(19) United States
(12) Patent Application Publication
(10) Pub. No.: US 2004/0215605 A1
(43) Pub. Date: Oct. 28, 2004

(54) System and method for managing a distributed equipment unit service reporting function over a network

(75) Inventor: David J. Mester, Fowlerville, MI (US)

Correspondence Address: BROOKS KUSHMAN P.C., 1000 TOWN CENTER, TWENTY-SECOND FLOOR, SOUTHFIELD, MI, 48075, US

(73) Assignee: Detroit Diesel Corporation, Detroit, MI

(21) Appl. No.: 10/423,372

(22) Filed: Apr. 25, 2003

(51) Int. Cl. G06F 7/00

(52) U.S. Cl. 707/3

(57) ABSTRACT

A system and method for providing distributed, or remote, equipment unit service reporting over a network. A database on a host computer communicates with a remote distributor computer that generates a unit down report. Technical support personnel receives the unit down report, initiates corrective action, and provides corrective action data to the host computer. The unit down report is updated to include the corrective action data. Distributor computers and management computers are linked to the host computer. A management computer may provide backup service hardware and engineering product support as needed to the distributor or dealer. Access to data fields in the host computer may be limited. The unit down report may be stored to create a historical record and may be organized and searchable depending upon specified criteria.

### BACKGROUND OF THE INVENTION

1. Field of the Invention

The present invention relates to remote equipment service support.

2. Background Art

Providing service for remotely located equipment presents special problems relating to communication difficulties, service parts availability, communicating instructions, and relating to obtaining data for management information reports. Examples of service operations that face these types of problems include service operations for on-highway trucks, off-highway trucks, agricultural equipment, ships, locomotives, airplanes, motor vehicles, and the like.

As an example, but not by way of limitation, on-highway and off-highway trucks having compression ignition engines require substantial service support in the field. Prior art engine service support systems suffer from a lack of communication between dealers and distributors to whom drivers turn when they require service. A need for service may arise unexpectedly anywhere across a wide ranging area. Engine manufactures that have service support and warranty obligations may not be promptly notified of a problem for a specific engine until well after it is taken out of service for repairs. For example, an owner or a truck driver may bring a truck in for service at a dealership that is overburdened or otherwise cannot immediately attend to servicing of the engine. The truck may sit for several days or weeks awaiting an initial diagnostic evaluation. During this time the dealer, distributor or management of engine manufacturer may not even be aware of the extent of an engine problem.

If service parts for an engine repair or an engine replacement is required, a request may not be processed immediately upon bringing the engine in for service. After waiting several weeks to evaluate the service requirements, additional delays may be incurred due to the need to order service parts or a replacement engine. Even further delays may be encountered if it is necessary to locate service parts that may not be readily available at a service parts warehouse.

Information used to support service operations such as service manuals and service parts catalogs used in service facilities may be outdated or incomplete. Many products, such as compression ignition engines, may be manufactured according to special orders requiring unique hardware and software calibrations that may not be generally available to a distributor or dealer service parts facility. Fire engines, ambulances, specialized airport vehicles and the like may have specialized engines or other components that require additional instructional tools. Normal service manuals may not include details relating to such speciality vehicles. New products, unusual applications or research and development products also may require specialized instructional tools that are not generally available to distributors and dealers who service such remote equipment units.

Lack of communication, parts availability and lack of comprehensive instructional tools result in costs being incurred for both the service provider and equipment operator. Delays are costly to service providers who may be required to air ship parts or contact manufacturers for specialized instructional tools. Even more importantly, equipment owners and operators are inconvenienced when service cannot be promptly and efficiently performed.

Cycle time is a term used by service providers to describe a time period from when an equipment unit goes down or is taken out of service until it is returned to service. Service providers require, but are seldom provided with, management information reports that can provide accurate and comprehensive information relating to service cycle time. Without such information it is difficult to measure progress in improving cycle time that is key to providing better customer satisfaction in the service area.

These and other problems are addressed by applicant's invention as summarized below.

### SUMMARY OF THE INVENTION

According to the present invention, a system is provided for managing distributed equipment unit service reporting functions over a network. The system includes a database on a host computer and at least one remote distributor computer that generates a unit down report that is communicated to the host computer. Technical support personnel receive the unit down report from the distributor computer and initiate corrective action. Corrective action data is provided to the host computer and is also communicated to the distributor computer. The computer updates the unit down report to include the corrective action data and create an updated unit down report. The distributor computer and at least one management computer are linked to the host computer. The distributor computer has access to the unit down reports and updated unit down reports. The management computer provides backup service hardware, such as replacement engines or replacement parts, and engineering products support, as needed, to the distributor.

According to the method provided by the present invention, a distributed equipment unit service reporting function is managed over a network. The method comprises providing a database on a host computer and providing at least one remote distributor computer. The unit down report is generated at the distributor computer and communicated to the host computer. The unit down report is reported to a technician who recommends corrective action and generates corrective action data. The corrective action data is communicated to the distributor computer and used to update the unit down report at the host computer. Service hardware instructions are provided to the distributor computer. The distributor computer, and at least one management computer are linked to the host computer to thereby provide access to the unit down reports and updated unit down reports.

Other aspects of the system and method of the present invention further comprise that the distributor computer communicates with the host computer database and is limited to a set of data fields that are limited to the distributor's associated data fields. The distributor computer preferably communicates the unit down report via an extranet automatic notification process. The management computer also communicates with the host computer and can access all data fields, however, the management computer may be precluded from data entry. The management computer may be a technical service computer or a regional manager's computer.

The host computer stores unit down reports as open files and also stores updated unit down reports as either open or closed files. The files are closed after the service event has been completed and the unit is returned to service.

The remote equipment units may be categorized in various ways. The equipment units may be organized and searched according to the type of equipment unit, customer, and distributor.

The above aspects of the present invention should be understood as examples and not read in a limiting sense. Other aspects and advantages relating to the invention will be apparent in view of the attached drawings and following detailed description of an embodiment of the invention.

### BRIEF DESCRIPTION OF THE DRAWINGS

FIG. 1 is a flow chart illustrating the system for managing a distributed equipment unit service reporting function over a network in accordance with the present invention.

### DETAILED DESCRIPTION OF THE PREFERRED EMBODIMENT(S)

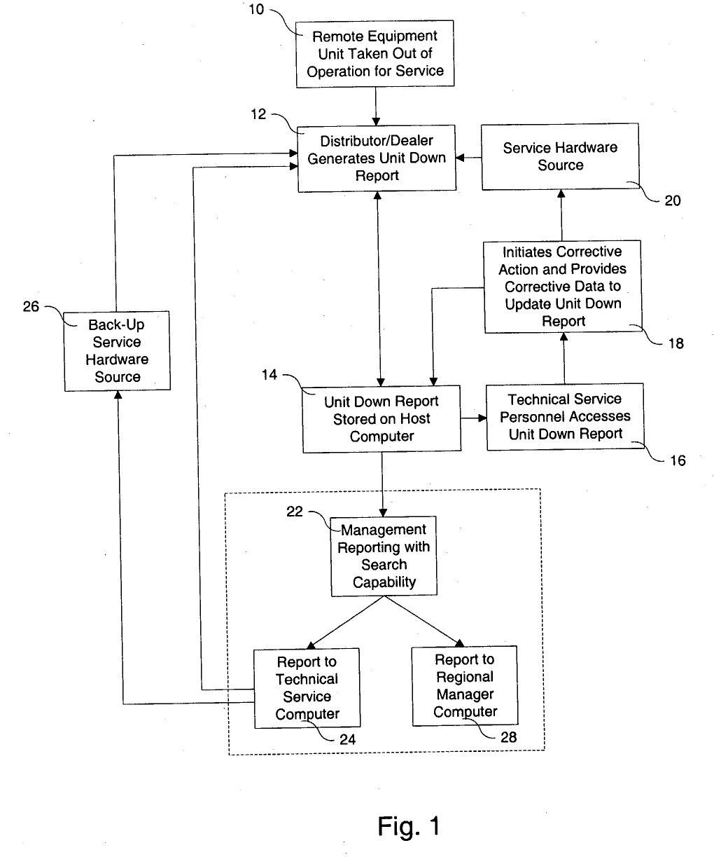

Referring now to FIG. 1, the system for managing a distributed equipment unit service reporting function over a network is illustrated by a flow chart. Initially, the remote equipment unit is taken out of operation for service at 10. The remote equipment unit may be a over the road truck, off-road truck, ship or ship's engine, airplane, locomotive, or the like. The unit may be taken out of service at any location where a distributor dealer service facility may be located. When the remote equipment unit is taken out of service the owner or operator of the equipment is not able to use the unit for its intended purpose until it is put back in service.

A distributor/dealer who is entrusted with the remote equipment unit generates a unit down report on the distributor/dealer's computer at 12. The unit down report is transmitted to a host computer and, at 14, is stored on the host computer. The host computer may be a mainframe computer, a network, or personal computer depending upon the resources available and requirements of the network.

Technical service personnel may access the unit down report at 16. Technical service personnel determine the nature and scope of the service required based upon the unit down report. Technical service personnel then, at 18, initiates corrective action and provides corrective data that is used to update the unit down report. The corrective action may include providing instructions to the distributor dealer through the host computer or by direct contact to the distributor dealer. The corrective action initiated may also include ordering from a service hardware source, at 20, appropriate service hardware that will be required by the distributor/dealer to perform the service operation. Service hardware may be either service parts or may even be a replacement unit if there is a catastrophic failure of the unit. A service hardware source 20 may be a service parts warehouse or manufacturing facility. The technical service personnel may use the system to determine the part or replacement unit inventory availability and make arrangements for shipment of parts or replacement units to the service facility. The updated unit down report is made available to the distributor dealer at 12 by means of a network. The network may be an extranet network, or the like, that is enabled for bidirectional communication between the host computer and the distributor/dealer computer.

The system also provides management reporting with search capability, at 22. Management reporting may be limited to a read only function that precludes data entry by management to protect the data received from the distributor/dealer when they generate the unit down report. The management reporting facility may report to a technical service computer at 24 that can provide supplemental or additional types of service support to the distributor/dealer. The technical service computer may provide additional engineering support to allow servicing of speciality products. For example, specialty products that use compression ignition engines include fire trucks, ambulances, airport speciality vehicles, research and development vehicles and other uniquely configured units. The technical service computer may also provide additional support in the form of backup service hardware sources, at 26. Backup service hardware may be required if a normal service hardware source is not able to provide appropriate service hardware due to lack of inventory or if the service hardware is specially configured.

Finally, management reporting function 22 may provide a report to a regional manager computer, at 28, so that the regional manager may monitor the service facilities of distributors and dealers within a region. The regional manager may use information from unit down reports and updated unit down reports to determine cycle time for service and monitor specific service events. In this way, the regional managers may provide management control and improve customer satisfaction with equipment service performance.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A system for managing a distributed equipment unit service reporting function over a network, comprising:
a database on a host computer;
at least one remote distributor computer that generates a unit down report that is communicated to the host computer;
a technical support personnel receives the unit down report from the distributor computer and initiate corrective action by providing corrective action data to the host computer that is also communicated to the distributor computer;
the host computer updates the unit down report to include the corrective action data and create an updated unit down report;
the distributor computer, and at least one management computer, are linked to the host computer, the distributor computer and has access to the unit down reports and updated unit down reports; and
the management computer providing back-up service hardware and engineering product support, as needed, to the distributor.

2. The system of claim 1 wherein the distributor computer communicates with the host computer database and is limited to a set of data fields that are limited the distributor's associated data fields.

3. The system of claim 1 wherein the management computer communicates with the host computer and can access all data fields, the management computer being precluded from data entry.

4. The system of claim 1 wherein the distributor computer communicates the unit down report via an extranet automatic notification process.

5. The system of claim 1 wherein the management computer is at least one technical service computer is linked to the host computer and has access to the unit down reports and updated unit down reports.

6. The system of claim 1 wherein the management computer is at least one regional manager computer is linked to the host computer and has access to the unit down reports and updated unit down reports.

7. The system of claim 1 wherein the host computer stores the unit down reports and updated unit down reports as a historical record.

8. The system of claim 1 wherein the equipment units are categorized in a plurality of different types and the unit down reports and updated unit down reports are organized and searchable by type of equipment unit.

9. The system of claim 1 wherein the equipment units are categorized according to a plurality of different customers and the unit down reports and updated unit down reports are organized and searchable by customer.

10. The system of claim 1 wherein the equipment units are categorized according to a plurality of different distributors and the unit down reports and updated unit down reports are organized and searchable by distributor.

11. A method of managing a distributed equipment unit service reporting function over a network, comprising:
providing a database on a host computer;
providing at least one remote distributor computer;
generating a unit down report at the distributor computer;
communicating the unit down report to the host computer;
communicating the unit down report to a technician who takes corrective action;
generating corrective action data by the technician;
communicating the corrective action data to the distributor computer;
updating the unit down report at the host computer to include the corrective action data report to create an updated unit down report;
providing service hardware and instructions to the distributor computer; and
linking the distributor computer, and at least one management computer to the host computer and providing access to the unit down reports and updated unit down reports.

12. The method of claim 11 wherein the distributor computer communicates with the host computer and is limited to a set of data fields that are limited the distributor's associated data fields.

13. The method of claim 11 wherein the management computer is linked to the host computer and can access all data fields, the management computer being precluded from data entry.

14. The method of claim 11 wherein the distributor computer communicates the unit down report via an extranet automatic notification process.

15. The method of claim 11 wherein the management computer is at least one technical service computer linked to the host computer and has access to the unit down reports and updated unit down reports.

16. The method of claim 11 wherein the management computer is at least one regional manager computer linked to the host computer and has access to the unit down reports and updated unit down reports.

17. The method of claim 11 further comprising storing on the host computer the unit down reports and updated unit down reports as a historical record.

18. The method of claim 11 further comprising categorizing the equipment units into a plurality of different types and organizing the unit down reports and updated unit down reports to be searchable by type of equipment unit.

19. The method of claim 11 further comprising categorizing the equipment units according to a plurality of different customers and organizing the unit down reports and updated unit down reports to be searchable by customer.

20. The method of claim 11 further comprising categorizing the equipment units according to a plurality of different distributors and organizing the unit down reports and updated unit down reports to be searchable by distributor.
